(19) United States
(12) Patent Application Publication
(10) Pub. No.: US 2008/0146747 A1
(43) Pub. Date: Jun. 19, 2008

(54) Heat-Activatable Adhesive Tape for Flexible Printed Circuit Board (Fpcb) Bondings

(75) Inventor: Marc Husemann, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: TESA AG, HAMBURG (DE)

(21) Appl. No.: 11/722,104

(22) PCT Filed: Dec. 22, 2005
(86) PCT No.: PCT/EP2005/057130

§ 371 Date: Jul. 21, 2007

(30) Foreign Application Priority Data
Dec. 23, 2004 (DE) 10 2004 063 328.2
Dec. 23, 2004 (DE) 10 2004 063 329.0

(51) Int. Cl. C08G 65/34

(52) U.S. Cl. 525/397; 525/408

(57) ABSTRACT

Heat-activatable adhesive substance comprised of: i) an acrylate-containing block copolymer in a proportion of 40 to 98% by weight, ii) one or more tackifying epoxy resins and/or novolak resins and/or phenolic resins in a proportion of 2 to 60% by weight, and iii) optionally a curing agent for cross-linking the epoxy resins and/or novolak resins and/or phenolic resins, in a proportion of 0 to 10% by weight.

The invention relates to a heat-activable adhesive tape for bonding circuit boards, in particular, flexible and/or printed circuit boards, most particularly flexible printed circuit boards (FPCBs).

Adhesive tapes in the age of industrialization are widespread processing aids. Particularly for use in the electronics industry such tapes are subject to extremely exacting requirements.

At the present time there is a trend within the electronics industry to ever slimmer, lighter and faster components. In order to achieve this the demands imposed on the production operation are becoming ever greater. This is also affecting flexible printed circuit boards (FPCBs), which are very frequently used for electrically contacting IC chips or conventional printed circuit boards.

Flexible printed circuit boards (FPCBs) are therefore represented in a multiplicity of electronic devices, such as mobiles, car radios, computers, etc., for example. FPCBs are generally composed of layers of copper (b) and polyimide (a), with polyimide being bonded where appropriate to the copper foil.

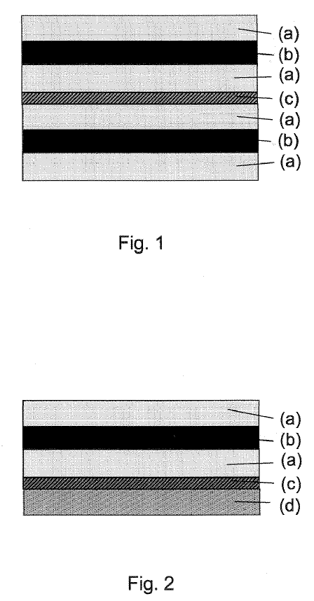

For the use of the FPCBs they are bonded, and in one version FPCBs are also bonded to one another. In that case polyimide film is bonded to polyimide film (FIG. 1).

FPCBs are generally bonded using heat-activable adhesive tapes (c) which do not emit volatile constituents and which can be used even in a high temperature range. In one alternative embodiment slightly tacky (adhesive to the touch) heat-activable adhesives may be used. These adhesive tapes can be prefixed and require only a gentle applied pressure for initial bonding.

A further application relates to the bonding of FPCBs (composed of polyimide (a) and copper (b)) with FR-4 epoxy sheets (d). These epoxy sheets are bonded in order to partially stiffen the FPCBs (FIG. 2).

Here as well use is made generally of heat-activable adhesive sheets (d). These sheets may also have adhesive properties in one particular embodiment.

The application of the bonding of FPCBs may also be taken further, however. FPCBs are presently there in virtually all electronic devices and accordingly require fixing. This fixing takes place by bonding to a very wide variety of substrates, although preference here is given to using plastic substrates, on account of their relatively low weight.

Generally speaking, for the purpose of bonding and for producing FPCBs, the heat-activable sheet must be self-crosslinking following temperature activation, since in general the bonded FPCBs also pass through a solder bath. For this reason it is not possible to use thermoplastics, in spite of their theoretical preference—they can be activated in just a few seconds, and accordingly it would be possible to build up the bond rapidly.

Unfortunately, simple thermoplastics become soft again at high temperatures and therefore lose solder bath resistance.

Further heat-activable adhesive tapes, such as the block copolymers described in U.S. Pat. No. 5,478,885 and based on epoxidized styrene-butadiene or styrene-isoprene, possess the disadvantage that they require very long cure times for complete curing and do not generally have any tack. They are only relatively slow to process.

The same applies to other epoxy-based systems, such as are described in WO 96/33248, for example. A further drawback of existing sheets is the softness of the heat-activable sheet at room or application temperature. Such heat-activable adhesive tapes are difficult to handle, since in the form of the free film they are difficult to transfer to the FPCB.

Another form of adhesive tapes are specific structural bonding tapes. These bonding tapes are based on polyacrylates, possess pressure-sensitive adhesion and cure with heating. Owing to their softness, they are likewise difficult to handle as free film and have a tendency to distort their shape.

Heat-activable adhesive tapes based on phenol resole resin are ruled out in general, since in the course of curing they emit volatile constituents and can therefore lead to blistering. Blistering is likewise undesirable, since it may result in disruption to the overall thickness of the FPCB and hence also in disruption to the functioning of the FPCB.

Accordingly there is a need for a heat-activable sheet which cures rapidly, is self-crosslinking and solder bath resistant, possesses good adhesion to polyimide and FR-4 (glass fiber mat bonded with epoxide resin), and can be handled readily, and drilled till a contact is achieved, as a free film at room temperature.

This object is achieved, surprisingly, by an adhesive as characterized more closely in the main claim. The dependent claims provide advantageous developments of the subject-matter of the invention.

In particular the adhesive is supplied in the form of an adhesive sheet.

The adhesive of the invention comprises
a) at least one acylate-containing block copolymer, the acrylate-containing block copolymers being present with a fraction of 40% to 98% by weight,
b) one or more tackifying epoxy and/or novolak and/or phenolic resins, with a fraction of 2% to 60% by weight.

The adhesive preferably further comprises
c) at least one hardener for crosslinking the epoxy, novolak and/or phenolic resins, with a fraction of up to 10% by weight, based on the adhesive incl. hardener.

The composition of the adhesive may be limited to components a) and b) and also a), b), and c), or in either of the two cases may feature further components.

The adhesive of the invention may in a first embodiment be present in a non-tacky or barely tacky configuration, while in a second embodiment it is supplied in a tacky embodiment.

Tack (“finger tack”, “instantaneous tack”) is the property possessed by contact adhesives of clinging immediately to substrates. Adhesives are said to be tacky or to have contact tack when they “stick” or “cling” to a substrate, with or without additional pressure acting on them.

Tacky contact adhesives display the tacky characteristics even without the application of higher applied pressures; pressure-sensitive contact adhesives exhibit tacky properties in particular as a result of the application of a certain pressure. Good contact adhesives already possess tack, in other words attach to a substrate even without the application of pressure, and bond to particularly good effect when a pressure is applied.

The invention also provides for the use of a heat-activable sheet comprising or consisting of
i) an acrylate-containing block copolymer, with a fraction of 40-98% by weight
ii) one or more tackifying epoxy and/or novolak and/or phenolic resins, with a fraction of 2-50% by weight
iii) if desired, a hardener for crosslinking the epoxy, novolak or phenolic resins, with a fraction of 0-10% by weight
   for adhesively bonding and/or producing circuit boards, in particular flexible printed circuit boards.

The invention also accordingly provides in particular heat-activable adhesives based on acrylate block copolymers, in which they comprise a combination of polymer blocks P(A) and P(B) which are linked chemically to one another and which under application conditions undergo segregation into at least two microphase-separated regions, the microphase-separated regions having softening temperatures in the range between −125° C. and +20° C., preferably between −100° C. and +20° C., more preferably between −80° C. and +20° C.

By softening temperature is meant in the context of this invention a glass transition temperature for amorphous systems and a melting temperature in the case of semi-crystalline polymers. The temperatures reported here correspond to those obtained from quasi-steady-state experiments, such as by means of DSC, for example.

In general the acrylate block copolymers are described by the stoichiometric formula [P(A)ᵢP(B)ⱼ]ₖ (I). With particular preference in accordance with the invention the copolymers used in heat-activable adhesives are diblock copolymers of formula (I) with i=j=k=1, and hence the block copolymers of simplest construction and easiest synthesis, and also triblock copolymers of formula (I) with i+j=3 (i, j>0) and k=1.

A and B here stand for one or else two or more monomers of type A and also for one or more monomers of type B (for detailed description see below), which can be used to prepare the respective polymer block. P(A) stands for a polymer block obtained by polymerizing at least one monomer of type A. P(B) stands for a polymer block obtained by polymerizing at least one monomer of type B.

In one advantageous embodiment of the invention, acrylate-containing block copolymers of the type P(A)-P(B), consisting of two interconnected polymer blocks P(A) and P(B) are used, it being possible for P(A) to be substituted by P(A/C) and/or P(B) to be substituted by P(B/D). P(A) and P(B) identify polymer blocks obtained by polymerizing at least one monomer of type A or by polymerizing at least one monomer of type B, respectively, while P(A/C) and P(B/D) identify copolymer blocks obtained by polymerizing at least one monomer of type A and at least one monomer of type C or, respectively, by polymerizing at least one monomer of type B and at least one monomer of type D.

Block copolymers which can be used with particular advantage in heat-activable adhesives of the invention and comprise two interconnected polymer blocks are those of the general type P(A)-P(B/D), in which each block copolymer is composed of a first polymer block P(A) and a copolymer block P(B/D) attached thereto, where
P(A) represents a polymer block, obtained by polymerizing at least one monomer of type A, P(A) having a softening temperature of between −125° C. and +20° C., preferably between −100° C. and +20° C., more preferably between −80° C. and +20° C.
P(B/D) represents a copolymer block, obtained by copolymerizing at least one monomer of type B and at least one monomer of type D, P(B/D) having a softening temperature of between −125° C. and +20° C., preferably between −100° C. and +20° C., more preferably between −80° C. and +20° C. Monomers of type D preferably possess at least one functional crosslinking group which behaves substantially inertly in a free-radical copolymerization reaction,
the polymer blocks P(A) and P(B/D) are in microphase-separated form under application conditions, and so the polymer blocks P(A) and P(B/D) are not completely (homogeneously) miscible under application conditions.

For the non-tacky or barely tacky alternative embodiment, the functional group of the monomers of type D is preferably chosen such that it serves in particular for the crosslinking of the reactive resin with the block copolymer. In the tacky alternative embodiment the functional group of the monomers D is preferably chosen such that it serves in particular to increase the cohesion of the block copolymer.

In a further advantageous embodiment, particularly in the case of the non-tacky or barely tacky alternative embodiment of the adhesive of the invention, the crosslinking action of the copolymer block P(B/D) can be brought about advantageously through the formation of bonds between the individual block copolymer macromolecules P(A)-P(B/D), with the crosslinking groups of the comonomers of type D of one block copolymer macromolecule reacting with at least one further block copolymer macromolecule. In this case the functional group of the comonomers of type D is with particular preference an epoxy group.

The cohesion-raising effect of the copolymer block P(B/D) can be brought about advantageously, especially for the tacky alternative embodiment of the adhesive of the invention, by means of bonds between the individual block copolymer macromolecules P(A)-P(B/D), the functional groups of the comonomers of type D of one block copolymer macromolecule interacting with at least one further block copolymer macromolecule. In this case, in a particularly advantageous way the functional group of the comonomers of type D brings about the desired raising of cohesion by means of dipole-dipole interactions and/or hydrogen bonds. The rise in cohesion additionally promotes the stiffness of the sheet and hence also its handling as a free film. A particularly preferred functional group of the comonomers of type D, especially for this tacky alternative embodiment, is a carboxylic acid group or a hydroxyl group.

Monomers of type A for the polymer block P(A) are preferably selected such that the resultant polymer blocks P(A) are capable of forming a two-phase microphase-separated structure with the copolymer blocks P(B/D). Block copolymers may have characteristics which, in terms of the compatibility of the blocks with one another, are similar to those of polymers that are present independently: on the basis of the incompatibility which generally exists between different polymers, these polymers, after having been mixed beforehand, separate out again, forming more or less homogeneous regions of the individual polymers. In the case of block copolymers (e.g., diblock, triblock, star block, multiblock copolymers), this incompatibility may also exist between the individual, different polymer blocks. Here it is then possible for the separation to occur only to a limited extent, however, since the blocks are connected to one another chemically. So-called domains (phases) are formed, in which two or more blocks of the same kind congregate. Since the domains are within the same order of magnitude as the original polymer blocks, the term “microphase separation” is used. The polymer blocks may form elongated, microphase-separated regions (domains), in the form for example of prolate, i.e., uniaxially elongated (e.g., rodlet-shaped) structural elements, oblate, i.e., biaxially elongated (e.g., layer-shaped) structural elements, three-dimensionally co-continuous microphase-separated regions, or a continuous matrix of one kind of polymer block (typically that with the higher weight fraction) with regions of the other kind of polymer block (typically that with the lower weight fraction) dispersed therein.

The fraction of the polymer blocks P(B/D) is preferably between about 20% and 95% by weight, more preferably between 25% and 80% by weight of the entire block copolymer.

Additionally the weight fraction of the comonomers of type D in the copolymer block P(B/D) in relation to the weight fraction of the monomers of type B is between 0% and 50%, preferably between 0.5% and 30%, more preferably between 1% and 20%.

Moreover, in a further inventive version, the heat-activable adhesives of the invention are based on block copolymers of the general type P(A/C)-P(B/D) and also those of the general type P(A)-P(B), where
P(A) and P(B) each represent a polymer block obtained by polymerizing at least one monomer of type A or by polymerizing at least one monomer of type B, respectively, P(A) and P(B) having a softening temperature of between −125° C. and +20° C., preferably between −100° C. and +20° C., more preferably between −80° and +20° C.
P(A/C) and P(B/D) each represent a copolymer block obtained by copolymerizing at least one monomer of type A or at least one monomer of type B and at least one monomer of type C or at least one monomer of type D, respectively, P(A/C) and P(B/D) having a softening temperature of between −125° C. and +20° C., preferably between −100° C. and +20° C., more preferably between −80° C. and +20° C. Monomers of type C and D possess at least one functional group which behaves substantially inertly in a free-radical polymerization reaction,
Polymer blocks P(A) and P(B) or polymer blocks P(A/C) and P(B/D) are in microphase-separated form under application conditions, and such polymer blocks are therefore not completely (homogeneously) miscible under application conditions.

For the non-tacky or barely tacky alternative embodiment, in turn, the functional group of the monomers of type D is preferably chosen such that it serves in particular for crosslinking of the reactive resin with the block copolymer, while in the tacky alternative embodiment it is chosen preferably such that it serves in particular to increase the cohesion of the block copolymer.

The fraction of the polymer blocks P(B) and P(B/D) is preferably between about 20% and 95% by weight, more preferably between 25% and 80% by weight of the entire block copolymer, so that polymer blocks P(B) and/or P(B/D) are able to form elongated microphase-separated regions, in the form for example of prolate (e.g. rodlet-shaped) or oblate (e.g. area-shaped) structural elements, three-dimensionally co-continuous microphase-separated regions or a continuous matrix with regions of the polymer blocks P(A) and/or P(A/C) dispersed therein.

Additionally the weight fraction of the comonomers of type D in the copolymer block P(B/D) in relation to the weight fraction of the comonomers of type B in the copolymer block P(B/D) is up to 50%, preferably between 0.5% and 30%, more preferably between 1% and 20%. The same applies to the weight fraction of the comonomers of type C in the copolymer block P(A/C) in relation to the weight fraction of the comonomers of type A in the copolymer block P(A/C), with it being possible, however, for the weight ratios to be selected independently from one another.

Block copolymers of general structure Z-P(A)-P(B)-Z′, Z-P(A/C)-P(B)-Z′, Z-P(A/C)-P(B/D)-Z′, where Z and Z′ can comprise further polymer blocks or else functional groups and where Z and Z′ may be identical or different can also be used with advantage in heat-activable adhesives of the invention.

Of particularly preferred utility in accordance with the invention are block copolymers which comprise a unit of three interconnected polymer blocks of type P(A)-P(B)-P(A′), it being possible for P(A) to be substituted by P(A/C) and/or for P(B) to be substituted by P(B/D) and/or for P(A′) to be substituted by P(A′/C′).P(A), P(B) and P(A′) identify polymer blocks obtained by polymerizing at least one monomer of type A, B or A′, respectively. P(A/C), P(B/D) and P(A′/C′) identify copolymer blocks obtained by copolymerizing at least one monomer of type A and one monomer of type C or at least one monomer of type B and one monomer of type D, or at least one monomer of type A′ and one monomer of type C′, respectively.

Structurally possible in accordance with the invention are not only symmetrical but also asymmetrical constructions of aforementioned block copolymers, in respect both of geometric parameters (e.g. block lengths and block length distribution, and block molar mass distribution) but also of the chemical structure of the polymer blocks. In the descriptions which follow it is assumed that both kinds of polymers, both symmetric and asymmetric, can be used in accordance with the invention. In order to keep the description readable the possibility of molecular asymmetry is not represented explicitly in every case.

Block copolymers which can be used with particular advantage in heat-activable adhesives of the invention, which comprise three interconnected polymer blocks, are those based on the general type P(A)-P(B/D)-P(A), in which each block copolymer is composed of a central copolymer block P(B/D) and two polymer blocks P(A) attached to it, where
P(B/D) represents a copolymer obtained by copolymerizing at least one monomer of type B and at least one monomer of type D, P(B/D) having a softening temperature of between −125° C. and +20° C., preferably between −100° C. and +20° C., more preferably between −80° C. and +20° C., the comonomer of type D possessing at least one functional group which behaves substantially inertly in a free-radical polymerization reaction,
P(A) represents a polymer block obtained by polymerizing at least one monomer of type A, P(A) having a softening temperature of between −125° C. and +20° C., preferably between −100° C. and +20° C., more preferably between −80° C. and +20° C.
Polymer blocks P(A) and P(B/D) are in microphase-separated form under application conditions, and so the polymer blocks P(A) and the polymer blocks P(B/D) are not completely (homogeneously) miscible under application conditions.

For the non-tacky or barely tacky alternative embodiment, in turn, the functional group of the monomers of type D is preferably chosen such that it serves in particular for crosslinking of the reactive resin with the block copolymer, while in the tacky alternative embodiment it is chosen preferably such that it serves in particular to increase the cohesion of the block copolymer.

In a further advantageous embodiment, particularly in the case of the non-tacky or barely tacky alternative embodiment of the adhesive of the invention, the crosslinking action of the copolymer block P(B/D) can be brought about advantageously by the formation of bonds between the individual block copolymer macromolecules P(A)-P(B/D), with the crosslinking groups of the comonomers of type D of one block copolymer macromolecule reacting with at least one further block copolymer macromolecule. In this case the functional group of the comonomers of type D is with particular preference an epoxy group.

The cohesion-raising effect of the copolymer block P(B/D) can be brought about advantageously, especially for the tacky alternative embodiment of the adhesive of the invention, by means of bonds between the individual block copolymer macromolecules P(A)-P(B/D), the functional groups of the comonomers of type D of one block copolymer macromolecule interacting with at least one further block copolymer macromolecule. In a particularly advantageous way the functional group of the comonomers of type D brings about the desired raising of cohesion by means of dipole-dipole interactions and/or hydrogen bonds. The increase in cohesion also promotes the rigidity of the sheet and thus also its handling as a free film. A particularly preferred functional group of the comonomers of type D is a carboxylic acid group or a hydroxyl group, especially for this tacky alternative embodiment.

Monomers of type A for the polymer blocks P(A) are preferably selected such that the resultant polymer blocks P(A) are capable of forming a two-phase microphase-separated structure with the copolymer blocks P(B/D). The fraction of the polymer blocks P(A) is preferably between 5% and 95% by weight, more preferably between 10% and 90% by weight of the overall block copolymer. It is further the case for the polymer block P(B/D) that the weight fraction of the monomers of type D in relation to the weight fraction of the monomers of type B is between 0% and 50%, preferably between 0.5% and 30%, more preferably between 1 and 20%.

Block copolymers which can be used with particular advantage in heat-activable adhesives of the invention are additionally those of the general type P(B/D)-P(A)-P(B/D), each block copolymer being composed of a central polymer block P(A) and two polymer blocks P(B/D) attached to it on either side, characterized in that
P(B/D) represents a copolymer obtained by copolymerizing at least one monomer of type B and at least one monomer of type D, P(B/D) having a softening temperature of between −125° C. and +20° C., preferably between −100° C. and +20° C., more preferably between −80° C. and +20° C., the monomers D possessing at least one functional group which behaves substantially inertly in a free-radical polymerization reaction,
P(A) characterizes a polymer obtained by polymerizing at least one monomer of type A, P(A) having a softening temperature of between −125° C. and +20° C., preferably between −100° C. and +20° C., more preferably between −80° C. and +20° C.
Polymer blocks P(A) and polymer blocks P(B/D) are in microphase-separated form, and so blocks P(B/D) and P(A) are not completely miscible under application conditions.

For the non-tacky or barely tacky alternative embodiment, in turn, the functional group of the monomers of type D is preferably chosen such that it serves in particular for crosslinking of the reactive resin with the block copolymer, and in the tacky alternative embodiment it is preferably chosen such that it serves in particular for increasing the cohesion of the block copolymer. For the barely tacky or non-tacky alternative embodiment, in turn, the functional groups used are preferably epoxy groups, while for the tacky alternative embodiment great preference is given to using carboxylic acid groups and/or hydroxyl groups.

Preferably the fraction of the polymer blocks P(A) is between 5% and 95% by weight, in particular between 10% and 90% by weight of the overall block copolymer.

Additionally the weight fraction of the comonomers of type D in the copolymer block P(B/D) in relation to the weight fraction of the comonomers of type B in the copolymer block P(B/D) is between 0% and 50%, preferably between 0.5% and 30%, more preferably between 1% and 20%.

Block copolymers which can be used with particular advantage in heat-activable adhesives of the invention are additionally those of the general type P(B/D)-P(A/C)-P(B/D), each block copolymer being composed of a central polymer block P(A/C) and two polymer blocks P(B/D) attached to it on either side, characterized in that
P(B/D) and P(A/C) each represent a copolymer block obtained by copolymerizing at least one monomer of type A or B and at least one monomer of type C or D, P(B/D) and P(A/C) having a softening temperature of between −125° C. and +20° C., preferably between −100° C. and +20° C., more preferably between −80° C. and +20° C., the monomers C and D possessing at least one functional group which behaves substantially inertly in a free-radical polymerization reaction, and which serves in particular for reacting with the reactive resin.
Polymer blocks P(A/C) and polymer blocks P(B/D) are in microphase-separated form, and so blocks P(B/D) and P(A/C) are not completely (homogeneously) miscible under application conditions.

For the non-tacky or barely tacky alternative embodiment, in turn, the functional group of the monomers of type C and/or D is preferably chosen such that it serves in particular for crosslinking of the reactive resin with the block copolymer, while in the tacky alternative embodiment it is chosen preferably such that it serves in particular to increase the cohesion of the block copolymer.

Preferably the fraction of the polymer blocks P(A/C) is between 5% and 95% by weight, in particular between 10% and 90% by weight of the overall block copolymer.

Preferably the weight fraction of the comonomers of type D in the copolymer block P(B/D) in relation to the weight fraction of the comonomers of type B in the copolymer block P(B/D) is up to 50%, preferably between 0.5% and 30%, more preferably between 1% and 20%. The same applies to the ratio of the weight fractions of the comonomers C and A in the copolymer block P(A/C).

Further advantageous and part of this invention are compounds of the general structure Z-P(A)-P(B)-P(A′)-Z′, it being possible for Z and Z′ to comprise further polymer blocks or else functional groups and for Z and Z′ to be identical or different. P(A), P(B) and P(A′) can also be in the form, optionally and independently of one another, of copolymer blocks P(A/C), P(B/D) and P(A′/C′), respectively. In specific cases it is possible for individual blocks to be omitted.

With particular advantage in accordance with the invention it is likewise possible to utilize linear and star-shaped multiblock copolymers whose structure is preferably as follows:

[P(E₁)]-[P(E₂)]-[P(E₃)]- . . . -[P(Eₘ)] with m>3 (II)

{[P(E_{1,δ}-]-[P(E_{2,δ}-]-[P(E_{3,δ}-)]- . . . -[P(E_{n,δ}-)]}ₓX with x>2, n>1, (III)
serial number 6=1, 2, . . . , x
   where
(II) identifies a linear multiblock copolymer composed of m polymer blocks P(E_{λ}) where λ=1 to m, in which each polymer block is of the type P(E), i.e. is composed of monomers of type E.
(III) is a star-shaped multiblock copolymer comprising a polyfunctional crosslinking region X, in which x polymer arms are joined to one another chemically and each polymer arm is composed of at least one polymer block P(E_{ν,δ}) where ν=1 to n, in which each polymer block is of the type P(E), i.e. is composed of monomers of type E.
P(E) can be substituted in each case by P(E/F), and P(E) represent polymer blocks obtained by polymerizing at least one monomer of type E, and P(E/F) represent copolymer blocks obtained by copolymerizing at least one monomer of type E and at least one monomer of type F.
The individual P(E) have a softening temperature of between −125 and +20° C., preferably between −100 and +20° C., more preferably between −80 and +20° C. Monomers of type C possess at least one functional group which behaves substantially inertly in a free-radical copolymerization reaction,
Polymers are in microphase-separated form under application conditions, and so the individual polymer blocks are not completely (homogeneously) miscible under application conditions.

In the case of the multiblock copolymer, λ is a serial number which serves to distinguish the polymer blocks of type P(E) in the multiblock copolymer and which runs from 1 to m. The individual polymer blocks P(E_{λ}) may differ in their construction and their length, though it is also possible for some or all of the polymer blocks P(E_{λ}) to be identical. In the case of the star-shaped polymer, ν denotes a serial number which serves here to distinguish the individual polymer blocks of type P(E) in each polymer arm. Some or all of the polymer blocks P(E_{ν,δ}) and/or of the polymer arms may be identical, though it is also possible for the individual “arms” to differ in the nature of the individual polymer blocks P(E_{ν,δ}), in the sequence of the n polymer blocks in each arm, and in the length of the individual polymer blocks. The different arms are symbolized in the above-indicated formula (III) by the serial number δ; the serial number δ therefore indicates that the x polymer arms joined to one another by chemical bonding in the polyfunctional crosslinking region may each have a different number of polymer blocks P(E) and/or a different construction.

The polyfunctional crosslinking region X (linkage point X) may be any structural unit which is capable of linking the individual polymer arms to one another chemically.

For the non-tacky or barely tacky alternative embodiment, in turn, the functional group of the monomers of type C is preferably chosen such that it serves in particular for crosslinking of the reactive resin with the block copolymer, and in the tacky alternative embodiment it is chosen preferably such that it serves in particular to increase the cohesion of the block copolymer.

In one preferred version of the invention the acrylate block copolymers exhibit one or more of the following criteria:
a (number average) molar mass Mₙ below 10 000 000 g/mol, preferably a molar mass between 30 000 g/mol and 1 000 000 g/mol,
a polydispersity D=M_{w}/Mₙ of less than 5, preferably less than 3;
one or more grafted-on side chains on the “main chains”.

The composition for the heat-activable adhesives can be varied within a wide frame by altering the identity and proportion of raw materials. It is also possible for further product properties, such as color and thermal or electrical conductivity, for example, to be obtained by targeted additions of colorants, organic and/or inorganic fillers and/or powders of metal or of carbon. Preferably the adhesive sheet has a thickness of 5-300 μm, more preferably between 10 and 50 μm.

### Monomers

Monomers of Type A, B and/or E

The monomers A for the polymer blocks P(A) and/or the copolymer blocks P(A/C), the monomers B for the polymer blocks P(B) and/or the copolymer blocks P(B/D) as well as the monomers E for the polymer blocks P(E) and/or the copolymer blocks P(E/F) of the adhesives used in accordance with the invention are preferably chosen such that the blocks interlinked in the block copolymer are not completely (homogeneously) miscible with one another and, consequently, form a two-phase structure. This structure includes domains composed of miscible block segments (including whole blocks in the ideal case) of different (and possibly also identical) chains. Prerequisites for miscibility are a chemically similar construction of these block segments or blocks and block lengths adapted to one another. The domains adopt a particular shape and superstructure depending on the volume fraction of a phase within the system as a whole. Depending on the choice of monomers used it is possible for the domains to differ in their softening/glass transition temperatures, their hardness and/or their polarity.

The monomers A, B or E, employed in the polymer blocks P(A), P(B) and P(E) and in the copolymer blocks P(A/C), P(B/D) and P(E/F) can be taken, in accordance with the invention from the same monomer pool, which is described below.

For the heat-activable adhesives of the invention described here it is advantageous to use acrylic monomers or vinyl monomers as monomers A, B or E, more preferably those monomers which lower the softening/glass transition temperature of the polymer block P(A) or of the polymer block P(B) or of the polymer block P(E), or of the copolymer block P(A/C)—also in combination with monomer C—or of the copolymer block P(B/D)—also in combination with monomer D—or of the copolymer block P(E/F)—also in combination with monomer F—to below 20° C.

When selecting the monomers A, B or E for the heat-activable adhesives of the invention great advantage attaches to using one or more compounds which can be described by the following general formula

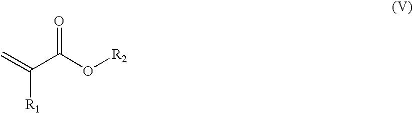

In this formula R₁═H or CH₃ and the radical R₂ is selected from the group consisting of branched and unbranched, saturated alkyl groups having 1 to 20 carbon atoms.

Acrylic monomers which are used with preference for the inventive heat-activable adhesive as monomers A, B, or E include in particular acrylic and methacrylic esters with alkyl groups consisting of 1 to 18 carbon atoms, preferably 4 to 9 carbon atoms. Specific examples, without wishing to be restricted by this enumeration, are methyl acrylate, ethyl acrylate, n-butyl acrylate, n-pentyl acrylate, n-hexyl acrylate, n-heptyl acrylate, n-octyl acrylate, n-nonyl acrylate, lauryl acrylate, stearyl acrylate and their branched isomers, such as 2-ethylhexyl acrylate, isobutyl acrylate and isooctyl acrylate, for example.

Further monomers regarding the type A, B and E monomers to be used for the polymer blocks P(A), P(B) and P(E) and/or the copolymer blocks P(A/C), P(B/D) and P(E/F) are monofunctional acrylates and methacrylates of bridged cycloalkyl alcohols composed of at least 6 carbon atoms. The cycloalkyl alcohols may also be substituted. Specific examples are cyclohexyl methacrylate, isobornyl acrylate, isobornyl methacrylate and 3,5-dimethyladamantyl acrylate.

Additionally use is made optionally, for the polymer blocks P(A), P(B) and P(E) and/or copolymer blocks P(A/C), P(B/D) and P(E/F), regarding monomers A, B and E, of vinyl monomers from the following groups:

vinyl esters, vinyl ethers, vinyl halides, vinylidene halides, vinyl compounds containing aromatic rings and heterocycles in oc position.

Here again mention may be made non-exclusively of some examples, particularly vinyl acetate, vinylformamide, ethyl vinyl ether, vinyl chloride, vinylidene chloride and acrylonitrile.

In addition, optionally, with particular preference for the barely tacky or non-tacky alternative embodiment of the adhesives of the invention, use is made as monomers of type A, B, and E for the polymer blocks P(A), P(B), and P(E) and copolymer blocks P(A/C), P(B/D), and P(E/F), of vinyl monomers, especially those from the following groups:

acrylic acid, hydroxyethyl acrylate, hydroxypropyl acrylate, hydroxyethyl methacrylate, hydroxypropyl methacrylate, n-methylolacrylamide, acrylic acid, methacrylic acid, allyl alcohol, maleic anhydride, itaconic anhydride, itaconic acid, phenoxyethyl acrylate, phenoxyethyl methacrylate, 2-butoxyethyl methacrylate, 2-butoxyethyl acrylate, cyano-ethyl methacrylate, cyanoethyl acrylate, 6-hydroxyhexyl methacrylate, tetrahydrofurfuryl acrylate, and acrylamide.

For the barely tacky or non-tacky alternative embodiment it is likewise preferred if, for the polymer blocks P(A), P(B), and P(E) and/or for the copolymer blocks P(A/C), P(B/D), and P(E/F), as monomers A, B, and E, vinyl monomers from the following groups are used: N,N-dialkyl-substituted amides, such as N,N-dimethylacrylamide, N,N-dimethylmethyl-methacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(buthoxymethyl)methacrylamide, N-methylolacrylamide, N-(ethoxymethyl)acrylamide, N-isopropylacrylamide; this listing should be considered as by way of example.

For the barely tacky or non-tacky embodiment it is advantageous if as monomers A, B, and E for the polymer blocks P(A), P(B), and P(E) and copolymer blocks P(A/C), P(B/D), and P(E/F), the (meth)acrylic monomers and/or vinyl monomers chosen are those which increase the softening/glass transition temperature of the copolymer block P(A/C)— also in combination with monomer A—or of the copolymer block P(B/D)—also in combination with monomer B—or of the copolymer block P(E/F)—also in combination with monomer E. Examples of corresponding monomers are methyl methacrylate, cyclohexyl methacrylate, tert-butyl acrylate, isobornyl methacrylate, benzyl acrylate, benzoin acrylate, acrylated benzophenone, benzyl methacrylate, benzoin methacrylate, methacrylated benzophenone, phenyl acrylate, phenyl methacrylate, tert-butylphenyl acrylate, tert-butylphenyl methacrylate, 4-biphenylyl acrylate, 2-naphthyl acrylate, and 2-naphthyl methacrylate, styrene, this listing not being conclusive.

Monomers of type A, B, and E that can be used with advantage for the barely tacky or non-tacky alternative embodiment for the polymer blocks P(A), P(B), and P(E) and copolymer blocks P(A/C), P(B/D), and P(E/F) are also vinyl monomers from the following groups:

vinylaromatic monomers, which may also be alkylated, functionalized or contain hetero-atoms, and which preferably possess aromatic nuclei of C₄ to C₁₈, also include α-methyl-styrene, 4-vinylbenzoic acid, the sodium salt of 4-vinylbenzenesulfonic acid, 4-vinylbenzyl alcohol, 2-vinylnaphthalene, 4-vinylphenylboronic acid, 4-vinylpyridine, phenyl vinylsulfonate, 3,4-dimethoxystyrene, vinyl benzotrifluoride, p-methoxystyrene, 4-vinyl-anisole, 9-vinylanthracene, 1-vinylimidazole, 4-ethoxystyrene, N-vinylphthalimide, this listing making no claim to completeness.

When synthesizing the block copolymers for the adhesives of the invention as claimed in the main claim and the subclaims, it is necessary to ensure when selecting the monomer combinations that the polymer blocks prepared from the monomers used are not completely miscible with one another.

The monomers B of the acrylate block copolymers of the invention—in all alternative embodiments—encompass the group of the monomers A. In one preferred version the monomer B for the polymer block B is different from the polymer A for the polymer block P(A). In the case of the version where two or more monomers are used for the polymer blocks P(A) or P(B), the monomers B are different from the monomers B or differ in their composition from the monomers A. In a further preferred version, the monomers B that are used differ from the monomers A in their number.

Monomers of Type C, D and/or F

In a preferred procedure the monomers used as monomers C, D and F for the copolymer blocks P(A/C), P(B/D) and P(E/F) are vinyl compounds, acrylates and/or methacrylates which carry functional groups.

In the case of the adhesives which are not tacky or barely tacky, these may preferably be, for example, epoxy or phenol groups.

In particular for the tacky alternative embodiments, polar groups may additionally or instead be present in the monomers, such as, for example, preferably carboxyl radicals, sulfonic and/or phosphonic acid groups, hydroxy radicals, lactam, lactone, N-substituted amides, N-substituted amines, carbamate, thiol, alkoxy or cyano radicals, ethers, halides.

Very advantageously for the heat-activable adhesives of the invention the monomers used as monomers C, D and F for the copolymer blocks P(A/C), P(B/D) and/or P(E/F) comprise one or more monomers having at least one functional group which can be described by the following general formula.

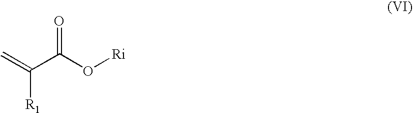

In this formula R₁═H or CH₃ and the radical Rᵢ═H or an organic radical containing at least one functional group and containing between 1 and 30 carbon atoms.

Particularly preferred examples of corresponding monomers containing vinyl groups suitably include, in particular for the alternative embodiment which is barely or not tacky, for example, glycidyl methacrylate, and in particular for the tacky variant, for example, acrylic acid, hydroxyethyl acrylate, hydroxypropyl acrylate, hydroxyethyl methacrylate, hydroxypropyl methacrylate, n-Methylolacrylamide, methacrylic acid, allyl alcohol, maleic anhydride, itaconic anhydride, itaconic acid, phenoxyethyl acrylate, phenoxyethyl methacrylate, 2-butoxyethyl methacrylate, 2-butoxyethyl acrylate, cyanoethyl methacrylate, cyanoethyl acrylate, 6-hydroxyhexyl methacrylate, tetrahydrofurfuryl acrylate and acrylamide.

Moderate basic monomers C, D and F for the copolymer blocks P(A/C), P(B/D) and P(E/F) in particular in the case of tacky alternative embodiments are, for example, N,N-dialkyl-substituted amides, such as N,N-dimethylacrylamide, N,N-dimethyl-methacrylamide, N-vinylpyrrolidone, N-vinyllactam, dimethylaminoethyl acrylate, dimethylaminoethyl methacrylate, diethylaminoethyl methacrylate, diethylaminoethyl acrylate, N-methylolacrylamide, N-methylolmethacrylamide, N-(butoxymethyl)-methacrylamide, N-(ethoxymethyl)acrylamide, and N-isopropylacrylamide, this enumeration being intended to be regarded as by way of example.

As monomers regarding the type C, D and F especially in the case of the tacky alternative embodiments, for the copolymer blocks P(A/C), P(B/D) and P(E/F) it is additionally possible to advantageously use vinylphosphonic acid, vinylsulfonic acid and the sodium salt of vinylsulfonic acid.

As monomers regarding the type C, D and F for the copolymer blocks P(A/C), P(B/D) and P(E/F) it is also possible, furthermore, to use zwitterionic monomers, this is also very advantageous, especially in the case of the tacky alternative embodiment. By way of example, mention may be made of the group of the betaines, for example. Examples of suitable betaines include ammonium carboxylates, ammonium phosphates and ammonium sulfonates. Specific examples include N-(3-sulfopropyl)-N-acryloyloxyethyl-N,N-dimethylammonium betaine, 1-(3-sulfopropyl)-2-vinylpyridinium betaine and N-(3-sulfopropyl)-N-allyl-N,N-dimethylammonium betaine. Particularly preferred examples are N-(3-sulfopropyl)-N-methacryloyloxyethyl-N,N-dimethylammonium betaine and N-(3-sulfopropyl)-N-acryloyloxyethyl-N,N-dimethylammonium betaine. N-(3-Sulfopropyl)-N-methacryloxyethyl-N,N-dimethylammonium betaine is available commercially from Raschig AG, Germany. This enumeration likewise possesses no claim to completeness.

Likewise suitable as monomers for monomers regarding the type C, D and F for the copolymer blocks P(A/C), P(B/D) and P(E/F) are, also in particular for the tacky alternative embodiment of the adhesives of the invention, (meth)acrylic monomers or vinyl monomers which increase the softening/glass transition temperature of the copolymer block P(A/C)—also in combination with monomer A—and/or of the copolymer block P(B/D)—also in combination with monomer B—and/or of the copolymer block P(E/F)—also in combination with monomer E. Examples of corresponding monomers for C, D and F are methyl methacrylate, cyclohexyl methacrylate, t-butyl acrylate, isobornyl methacrylate, benzyl acrylate, benzoin acrylate, acrylated benzophenone, benzyl methacrylate, benzoin methacrylate, methacrylated benzophenone, phenyl acrylate, phenyl methacrylate, t-butylphenyl acrylate, t-butylphenyl methacrylate, 4-biphenylyl acrylate, 2-naphthyl acrylate and 2-naphthyl methacrylate, and styrene, this enumeration not being conclusive.

Also particularly suitable for the tacky alternative embodiment are advantageous monomers regarding the type C, D and F for the copolymer blocks P(A/C), P(B/D) and P(E/F) are vinylaromatic monomers, which may also be alkylated and/or functionalized or contain heteroatoms and which preferably possess aromatic nuclei of C₄ to C₁₈, particularly including α-methylstyrene, 4-vinylbenzoic acid, the sodium salt of 4-vinyl-benzenesulphonic acid, 4-vinylbenzyl alcohol, 2-vinylnaphthalene, 4-vinylphenylboronic acid, 4-vinylpyridine, phenyl vinylsulfonate, 3,4-dimethoxystyrene, vinyl benzotrifluoride, p-methoxystyrene, 4-vinylanisole, 9-vinylanthracene, 1-vinylimidazole, 4-ethoxystyrene, and N-vinylphthalimide, this enumeration making no claim to completeness.

### Preparation of the Block Copolymers

The polymerization for preparing the block copolymers can be carried out by any method known per se or in modification of a method known per se, in particular by means of conventional free-radical addition polymerization and/or by means of controlled free-radical addition polymerization; the latter is characterized by the presence of suitable control reagents.

To prepare the block copolymers it is possible in principle to use all polymerizations which proceed in accordance with a controlled or living mechanism, including combinations of different controlled polymerization methods. Without possessing any claim to completeness, mention may be made here, by way of example, besides anionic polymerization, of ATRP, nitroxide/TEMPO-controlled polymerization or, more preferably, the RAFT process; in other words, particularly those methods which allow control over the block lengths, polymer architecture or else, but not necessarily, the tacticity of the polymer chain.

Radical polymerizations can be conducted in the presence of an organic solvent or in the presence of water or in mixtures of organic solvents and/or organic solvent with water, or without solvent. When carrying out the polymerization in organic solvents it is preferred to use as little solvent as possible. Depending on conversion and temperature, the polymerization time for radical processes is typically between 4 and 72 h.

In the case of solution polymerization the solvents used are preferably esters of saturated carboxylic acids (such as ethyl acetate), aliphatic hydrocarbons (such as n-hexane, n-heptane or cyclohexane), ketones (such as acetone or methyl ethyl ketone), special boiling point spirit, aromatic solvents such as toluene or xylene, or mixtures of aforementioned solvents. For polymerization in aqueous media or in mixtures of organic and aqueous solvents it is preferred to add emulsifiers and/or stabilizers for the polymerization.

Where a method of radical polymerization is employed it is advantageous to make use, as polymerization initiators, of customary radical-forming compounds, such as peroxides, azo compounds and peroxosulfates, for example. Initiator mixtures also possess outstanding suitability.

In an advantageous procedure radical stabilization is effected using nitroxides of type (VIIa) or (VIIb):

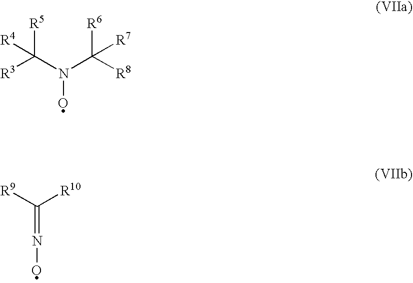

where R³, R⁴, R⁵, R⁶, R⁷, R⁸, R⁹ and R¹⁰ independently of one another denote the following compounds or atoms:
i) halogens, such as chlorine, bromine or iodine
ii) linear, branched, cyclic and heterocyclic hydrocarbons having 1 to 20 carbon atoms, which can be saturated, unsaturated or aromatic,
iii) esters —COOR¹¹, alkoxides —OR¹² and/or phosphonates —PO(OR¹³)₂, where R¹¹, R¹² or R¹³ stand for radicals from group ii).

Compounds of structure (VIIa) or (VIIb) may also be attached to polymer chains of any kind (primarily in the sense that at least one of the abovementioned radicals constitutes such a polymer chain) and can therefore be used as macroradicals or macroregulators to construct the block copolymers.

Very strongly preferred as controlled regulators for the polymerization are selected compounds of the following types:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide

U.S. Pat. No. 4,581,429 A discloses a controlled-growth radical polymerization method initiated using a compound of formula R′R″N—O—Y in which Y is a free-radical species which is able to polymerize unsaturated monomers. The reactions, however, generally have low conversions. A problem is the polymerization of acrylates, which proceeds only to very low yields and molar masses. WO 98/13392 A1 describes open-chain alkoxyamine compounds which have a symmetrical substitution pattern. EP 735 052 A1 discloses a method of preparing thermoplastic elastomers having narrow molar mass distributions. WO 96/24620 A1 describes a polymerization method using very specific radical compounds, such as phosphorus-containing nitroxides based on imidazolidine, for example. WO 98/44008 A1 discloses specific nitroxyls based on morpholines, piperazinones and piperazinediones. DE 199 49 352 A1 describes heterocyclic alkoxyamines as regulators in controlled-growth radical polymerizations. Corresponding further developments of the alkoxyamines and of the corresponding free nitroxides improve the efficiency for preparing polyacrylates.

As a further controlled polymerization technique it is possible advantageously to use atom transfer radical polymerization (ATRP) to synthesize the block copolymers, with preferably monofunctional or difunctional secondary or tertiary halides being used as initiator and, to abstract the halide(s), complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The different possibilities of ATRP are also described in the publications U.S. Pat. No. 5,945,491 A, U.S. Pat. No. 5,854,364 A and U.S. Pat. No. 5,789,487 A.

In a further controlled polymerization method 1,1-diphenylethylene is used as a control reagent. The preparation of block copolymers by this route has likewise been described (Macromol. Chem. Phys., 2001, 22, 700).

It is additionally possible with advantage to prepare the block copolymers utilized in accordance with the invention by means of an anionic polymerization. In this case the reaction medium used preferably comprises inert solvents, such as aliphatic and cycloaliphatic hydrocarbons, for example, or else aromatic hydrocarbons.

The living polymer is generally represented by the structure P_{L}(A)-Me, in which Me is a metal from group I, such as lithium, sodium or potassium, and P_{L}(A) is a growing polymer block of the monomers A. The molar mass of the polymer block under preparation is determined by the ratio of initiator concentration to monomer concentration. In order to construct the block structure, first of all the monomers A are added for the construction of a polymer block P(A), then, by adding the monomers B, a polymer block P(B) is attached, and subsequently, by again adding monomers A, a further polymer block P(A) is polymerized on, so as to form a triblock copolymer P(A)-P(B)-P(A). Alternatively P(A)-P(B)-M can be coupled by means of a suitable difunctional compound. By this route star-shaped multiblock copolymers of formula (IV) as well are obtainable.

Examples of suitable polymerization initiators include n-propyllithium, n-butyllithium, sec-butyllithium, 2-naphthyllithium, cyclohexyllithium or octyllithium, this enumeration making no claim to completeness. Also known, and suitable for use here, are initiators based on rare earth element complexes for the polymerization of acrylates (Macromolecules, 1995, 28, 7886).

It is also possible, moreover, to use difunctional initiators, such as 1,1,4,4-tetraphenyl-1,4-dilithiobutane or 1,1,4,4-tetraphenyl-1,4-dilithioisobutane, for example. Coinitiators may likewise be used. Suitable coinitiators include lithium halides, alkali metal alkoxides or alkylaluminium compounds. In one very preferred version the ligands and coinitiators are chosen so that acrylate monomers, such as n-butyl acrylate and 2-ethylhexyl acrylate, can be polymerized directly and do not have to be generated in the polymer by transesterification with the corresponding alcohol.

After the anionic polymerization it is advisable to carry out a polymer-analogous reaction in order to liberate polar groups. One possibility for preparing acrylate block copolymers functionalized with carboxylic acid groups involves the anionic polymerization of tert-butyl acrylate followed if desired by hydrolysis of the tert-butyl group with trifluoroacetic acid, thereby liberating the carboxylic acid group.

A very preferred preparation process conducted is a variant of the RAFT polymerization (reversible addition-fragmentation chain transfer polymerization). The polymerization process is described in detail, for example, in the publications WO 98/01478 A1 and WO 99/31144 A1. Suitable with particular advantage for the preparation of triblock copolymers are trithiocarbonates of the general structure R′″-S—C(═S)—S—R′″ (Macro-molecules 2000, 33, 243-245), by means of which, in a first step, monomers for the end blocks P(A) are polymerized. Then, in a second step, the central block P(B) is synthesized. Following the polymerization of the end blocks P(A) the reaction can be terminated and reinitiated. It is also possible to carry out polymerization sequentially without interrupting the reaction. In one very advantageous variant, for example, the trithiocarbonates (VIII) and (IX) or the thio compounds (X) and (XI) are used for the polymerization, it being possible for φ to be a phenyl ring, which can be unfunctionalized or functionalized by alkyl or aryl substituents attached directly or via ester or ether bridges, or to be a cyano group, or to be a saturated or unsaturated aliphatic radical. The phenyl ring φ may optionally carry one or more polymer blocks, corresponding to the definition of P(A), P(B), P(A/C) and P(B/D). Functionalizations may, for example, be halogens, hydroxyl groups, groups containing nitrogen or sulfur, with this list making no claim to completeness.

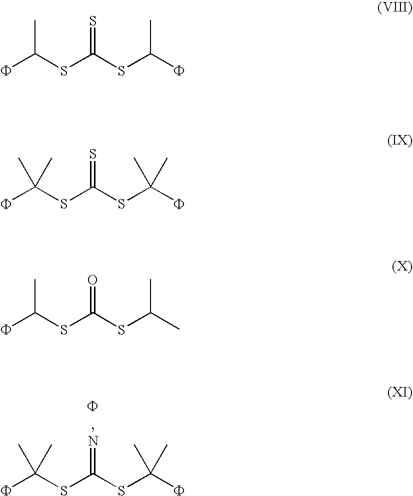

It is additionally possible to employ thioesters of the general structure R^{IV}-C(═S)—S-R^{V}, particularly in order to prepare asymmetric systems. R^{IV} and R^{V} can be selected independently of one another and R^{IV} can be a radical from one of the following groups i) to iv) and R^{V} a radical from one of the following groups i) to iii):
i) C₁ to C₁₈ alkyl, C₂ to C₁₈ alkenyl, C₂ to C₁₈ alkynyl, each linear or branched; aryl-, phenyl-, benzyl-, aliphatic and aromatic heterocycles.
ii) —NH₂, —NH—R^{VI}, —NR^{VI}R^{VII}, —NH—C(═O)—R^{VI}, —NR^{VI}—C(═O)—R^{VII}, —NH—C(═S)—R^{VI}, —NR^{VI}—C(═S)—R^{VII},

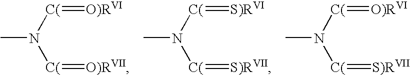

with R^{VI} and R^{VII} being radicals selected independently of one another from group i).
iii) —S—R^{VIII}, —S—C(═S)—R^{VIII}, with R^{VIII} being able to be a radical from one of groups i) and ii).
   iv) —O—R^{VIII}, —O—C(═O)—R^{VIII}, with R^{VIII} being able to be a radical from one of groups i) and ii).

In connection with the abovementioned polymerizations which proceed by controlled radical mechanisms it is preferred to use initiator systems which further comprise additional radical initiators for the polymerization, especially thermally decomposing radical-forming azo or peroxo initiators. In principle, however, all customary initiators known for acrylates are suitable for this purpose. The production of C-centered radicals is described in Houben-Weyl, Methoden der Organischen Chemie, Vol. E19a, p. 60 ff. These methods are preferentially employed. Examples of radical sources are peroxides, hydroperoxides and azo compounds. A few non-exclusive examples of typical radical initiators that may be mentioned here include the following: potassium peroxodisulfate, dibenzoyl peroxide, cumene hydroperoxide, cyclohexanone peroxide, cyclohexyl-sulphonyl acetyl peroxide, di-tert-butyl peroxide, azodiisobutyronitrile, diisopropyl percarbonate, tert-butyl peroctoate, and benzpinacol. In one very preferred variant the radical initiator used is 1,1′-azobis(cyclohexylnitrile) (Vazo 88®, DuPont®) or 2,2-azobis(2-methylbutanenitrile) (Vazo 67®, DuPont®). It is also possible, furthermore, to use radical sources which release radicals only under UV irradiation.

In the case of the conventional RAFT process polymerization is generally carried out only to low conversions (WO 98/01478 A1), in order to obtain very narrow molecular weight distributions. Because of the low conversions, however, these polymers cannot be used as heat-activable adhesives and in particular not as hotmelt adhesives, since the high residual monomer fraction adversely affects the adhesive properties, the residual monomers contaminate the solvent recyclate in the concentration process, and the corresponding self-adhesive tapes would exhibit very high outgassing.

In accordance with the invention, therefore, the solvent is preferably stripped off in a concentrative extruder under reduced pressure, for which purpose it is possible to use, for example, single-screw or twin-screw extruders, which preferably distil off the solvent in different or the same vacuum stages and which preferably possess a feed preheater.

### Resins

The epoxy resins used and described in the context of this invention embrace the entire group of epoxy compounds. Thus the epoxy resins may be monomers, oligomers or polymers. Polymeric epoxy resins can be aliphatic, cycloaliphatic, aromatic or heterocyclic in nature. The epoxy resins preferably have at least two epoxy groups which can be used for crosslinking.

The molecular weight of the epoxy resins varies preferably from 100 g/mol up to a maximum of 25 000 g/mol for polymeric epoxy resins.

The epoxy resins comprise, for example, the reaction product of bisphenol A and epichlorohydrin, the reaction product of phenol and formaldehyde (novolak resins) and epichlorohydrin, glycidyl ester, the reaction product of epichlorohydrin and p-aminophenol.

Preferred commercial examples include Araldite™ 6010, CY-281™, ECN™ 1273, ECN™ 1280, MY 720, RD-2 from Ciba Geigy, DER™ 331, DER™ 732, DER™ 736, DEN™ 432, DEN™ 438, DEN™ 485 from Dow Chemical, Epon™ 812, 825, 826, 828, 830, 834, 836, 871, 872, 1001, 1004, 1031 etc. from Shell Chemical and HPT™ 1071, HPT™ 1079 likewise from Shell Chemical.

Examples of commercial aliphatic epoxy resins include vinylcyclohexane dioxides, such as ERL-4206, ERL-4221, ERL 4201, ERL-4289 or ERL-0400 from Union Carbide Corp.

Other resins may advantageously be added to the adhesives of the invention. Suitable resins are all natural and synthetic resins, such as rosin derivatives (for example derivatives formed by disproportionation, hydrogenation or esterification), coumarone-indene resins and polyterpene resins, aliphatic or aromatic hydrocarbon resins (C-5, C-9, (C-5)₂ resins), mixed C-5/C-9 resins, hydrogenated and partly hydrogenated derivatives of the aforementioned types, resins of styrene or α-methylstyrene, and also terpene-phenolic resins and others as listed in Ullmanns Enzyklopadie der technischen Chemie, volume 12, pp. 525-555 (4th ed.), Weinheim.

As reactive resin components it is additionally possible as well, optionally, to use phenolic resins, such as YP 50 from Toto Kasei, PKHC from Union Carbide Corp. and BKR 2620 from Showa Union Gosei Corp., for example.

As reactive resins it is additionally possible as well, optionally, to use polyisocyanates, such as Coronate™ L from Nippon Polyurethane Ind., Desmodur™ N3300 or Mondur™ 489 from Bayer, for example.

Suitable resins are all natural and synthetic resins, such as rosin derivatives (for example derivatives formed by disproportionation, hydrogenation or esterification), coumarone-indene resins and polyterpene resins, aliphatic or aromatic hydrocarbon resins (C-5, C-9, (C-5)₂ resins), mixed C-5/C-9 resins, hydrogenated and partly hydrogenated derivatives of the aforementioned types, resins of styrene or α-methylstyrene, and also terpene-phenolic resins and others as listed in Ullmanns Enzyklopadie der technischen Chemie, volume 12, pp. 525-555 (4th ed.), Weinheim.

As reactive resin components it is additionally possible as well, optionally, to use phenolic resins, such as YP 50 from Toto Kasei, PKHC from Union Carbide Corp. and BKR 2620 from Showa Union Gosei Corp., for example.

As reactive resins it is additionally possible as well, optionally, to use polyisocyanates, such as Coronate™ L from Nippon Polyurethane Ind., Desmodur™ N3300 or Mondur™ 489 from Bayer, for example.

### Additives

In another embodiment of the invention, the heat-activable adhesive includes further formulating ingredients, such as, for example, fillers, pigments, rheological additives, additives for improving adhesion, plasticizers, elastomers, ageing inhibitors (antioxidants), light stabilizers, UV absorbers, and also other auxiliaries and additives, such as drying agents (for example molecular sieve, zeolites, calcium oxide), flow agents and levelling agents, wetters (surfactants) or catalysts, for example.

As fillers it is possible to use, in particular, all finely ground solid additives such as, for example, chalk, magnesium carbonate, zinc carbonate, kaolin, barium sulfate, titanium dioxide or calcium oxide. Further examples are talc, mica, silica, silicates or zinc oxide. Mixtures of the substances mentioned may also be used.

The pigments advantageously employed may be organic or inorganic in nature. All kinds of organic or inorganic color pigments are suitable, examples being white pigments such as titanium dioxide, for instance, for improving the light stability and UV stability, and also metallic pigments.

Examples of rheological additives are pyrogenic silicas, phyllosilicates (bentonites), high molecular mass polyamide powders or castor oil derivative powders.

Additives for improving the adhesion may be, for example, substances from the groups of the polyamides, epoxides or silanes.

Examples of plasticizers which can be added with great advantage to the adhesive are phthalic esters, trimellitic esters, phosphoric esters, esters of adipic acid, and other acyclic dicarboxylic esters, fatty acid esters, hydroxycarboxylic esters, alkylsulphonic esters of phenol, aliphatic, cycloaliphatic and aromatic mineral oils, hydrocarbons, liquid or semi-solid rubbers (for example nitrile rubbers or polyisoprene rubbers), liquid or semisolid polymers of butene and/or isobutene, acrylic esters, polyvinyl ethers, liquid resins and soft resins based on the raw materials which also constitute the basis for tackifier resins, woolwax and other waxes, silicones, and also polymeric plasticizers such as polyesters or polyurethanes, for instance.

In a further version of the invention it is possible for hardener systems to be added to the adhesive sheet. Here it is possible to use all of the hardeners that are known to the skilled person and which lead to a reaction with phenolic resins. This category embraces all formaldehyde donors, such as hexamethylenetretraamine or phenol resole resins, for example.

For crosslinking with epoxy resins and—where present—with the epoxy functionalized block copolymers use is made, for example, of difunctional or polyfunctional hydroxy compounds, difunctional or polyfunctional isocyanates, Lewis acids, such as zinc chloride or zinc oxide or zinc hydroxide, for example, or dicyandiamide.

In order to accelerate the crosslinking and to increase the network density it is further possible to add trifunctional or polyfunctional epoxides or hydroxides.

For an optional crosslinking reaction of the adhesives, further crosslinking-initiating and/or promoting additives may be added. Regarding this, see further below.

### Coating the Adhesives

The heat-activable adhesives can be applied directly, in an indirect transfer process, by coextrusion, from solution, from dispersion or from the melt.

In accordance with the method of application the block polymer is blended with the reactive resin or resins. For coating from solution it is preferred to add the reactive resin in solution to the block copolymer and to incorporate it by stirring. For this purpose it is possible to use the stirring technologies known to the skilled person. To prepare a homogeneous mixture it is also possible to use static or dynamic mixing units.

For coating from the melt the solvent is preferably stripped off in a concentrated extruder under reduced pressure, for which purpose it is possible, for example, to use single-screw or twin-screw extruders, which preferably distil off the solvent in identical or different vacuum stages and possess a feed preheater. In one preferred version the residual solvent fraction is below 1% by weight, very preferably below 0.5% by weight. Blending with the reactive resins is preferentially likewise undertaken in the melt. For this purpose it is possible to use kneading apparatus or, again, twin-screw extruders. Blending takes place preferably under hot conditions, although the activation temperature in the mixing unit ought to be well below the activation temperature for the reaction, for example, of the epoxy resins.

### Crosslinking

For the optional crosslinking with UV light, UV-absorbing photoinitiators are added to the heat-activable adhesives. Useful photoinitiators which can be used to great effect are benzoin ethers, such as benzoin methyl ether and benzoin isopropyl ether, substituted acetophenones, such as 2,2-diethoxyacetophenone (available as Irgacure 651° from Ciba Geigy®), 2,2-dimethoxy-2-phenyl-1-phenylethanone and dimethoxyhydroxyaceto-phenone, substituted α-ketols, such as 2-methoxy-2-hydroxypropiophenone, aromatic sulphonyl chlorides, such as 2-naphthylsulphonyl chloride, and photoactive oximes, such as 1-phenyl-1,2-propanedione 2-(O-ethoxycarbonyl) oxime, for example.

The abovementioned photoinitiators and others which can be used, including those of the Norrish I (α-cleaving photoinitiators, photo-fragmenting) or Norrish II (intramolecular hydrogen abstraction by a photochemically stimulated group) type, can contain the following radicals: benzophenone, acetophenone, benzil, benzoin, hydroxyalkylphenone, phenyl cyclohexyl ketone, anthraquinone, trimethylbenzoylphosphine oxide, methylthiophenyl morpholinyl ketone, amino ketone, azo benzoin, thioxanthone, hexaarylbisimidazole, triazine, or fluorenone radicals, it being possible for each of these radicals to be further substituted by one or more halogen atoms and/or one or more alkyloxy groups and/or one or more amino groups or hydroxyl groups. A representative overview is given by Fouassier: “Photoinitiation, Photopolymerization and Photocuring: Fundamentals and Applications”, Hanser-Verlag, Munich 1995. For further details it is possible to consult Carroy et al. in “Chemistry and Technology of UV and EB Formulation for Coatings, Inks and Paints”, Oldring (Ed.), 1994, SITA, London.

In principle, it is also possible to crosslink the, heat-activable adhesives using electron beams. Typical irradiation devices which may be employed are linear cathode systems, scanner systems and segmented cathode systems, in the case of electron beam accelerators. A detailed description of the state of the art and the most important process parameters can be found in Skelhorne, Electron Beam Processing, in Chemistry and Technology of UV and EB formulation for Coatings, Inks and Paints, Vol. 1, 1991, SITA, London. The typical acceleration voltages are in the range between 50 kV and 500 kV, preferably between 80 kV and 300 kV. The scatter doses employed range between 5 to 150 kGy, in particular between 20 and 100 kGy.

### Use of the Adhesives

The invention further provides for the use of the heat-activable adhesives as adhesive sheets for bonding polyimide-based FPCBs or else polyethylene naphthylate (PEN)-based and polyethylene terephthalate (PET)-based FPCBs. In these cases a high bond strength is achieved with the adhesive sheet.

Following appropriate converting it is possible to adhere diecuts or rolls of the inventive adhesive sheet to the substrate to be bonded (polyimide), at room temperature or at slightly elevated temperature.

In another variant the adhesive is coated onto a polyimide backing. Such adhesive tapes can then be used for masking copper conductor tracks for FPCBs.

The admixed reactive resins ought not yet to enter into any chemical reaction at the slightly elevated temperature. Hence it is not necessary for bonding to take place as a single-stage process; instead, the adhesive sheet can first be attached to one of the two substrates, by laminating the system under hot conditions. This preferably takes place with temperature activation, in particular for the barely tacky or non-tacky alternative embodiments.

In the course of the actual hot bonding operation to the second substrate (second polyimide film of the second FPCB) the resin then cures, completely or partly, and the adhesive joint attains the high bond strength, well above those of conventional PSA systems. In particular in the case of the barely tacky or non-tacky variants, the curing process runs its course preferably or incorporation of the functionalized block copolymer. The adhesive sheet is particularly suitable, accordingly, for a hot press process at temperatures above 80° C., preferably above 100° C., more preferably above 120° C.

In contrast to other adhesive sheets, which mostly are composed of pure epoxy resins, the heat-activable adhesive sheet of this invention has a high elastic component owing to the high acrylate block copolymer fraction. This tough, elastic behavior allows particularly effective compensation of the flexible movements of the FPCBs, so that even high stresses and peeling motions are effectively withstood.

### Experiments

The invention is described below, without any intention that it should be unnecessarily restricted through the choice of the examples.

The following test methods were employed.

### Test Methods

A. T-Peel Test with FPCB

The adhesive sheet is laminated onto the polyimide sheet of the polyimide/copper foil laminate at 100° C. Subsequently this operation is repeated with a second polyimide film so as to produce an adhesive joint between two polyimide/copper film laminates, the polyimide films being bonded to one another in each case. The assembly is cured by subjecting it to compression in a heatable press from Burkle at 170° C. for 30 minutes under a pressure of 50 N/cm².

Subsequently the assembly is pulled apart at a peel angle of 180° and at a speed of 50 mm/min, using a tensile testing machine from Zwick, and the force in N/cm is measured. The measurement is carried out at 20° C. under 50% humidity. The measurements are made three times and averaged.

### B. Solder Bath Resistance

An FPCB assembly bonded with the examples according to test method A is immersed completely for 10 seconds in a solder bath at 288° C. The bond is considered solder bath resistant if no air bubbles are formed which cause the polyimide film of the FPCB to expand. The test is failed if even slight bubble formation occurs.

C. Gel Permeation chromatography (GPC)

The average molecular weights Mₙ (number average) and M_{w} (weight average) and the polydispersity D were determined by gel permeation chromatography. The eluent used was THF containing 0.1% by volume trifluoroacetic acid. Measurement took place at 25° C. The precolumn used was PSS-SDV, 5μ, 10³ Å, ID 8.0 mm×50 mm. Separation was carried out using the columns PSS-SDV, 5μ, 10³ and also 10⁵ and 10⁶ each of ID 8.0 mm×300 mm. The sample concentration was 4 g/l, the flow rate 1.0 ml per minute. Measurement was made against PMMA standards.

### D. Rolling Ball Tack

The rolling ball test was carried out in analogy to ASTM D3121-94. This test was carried out using a steel ball with a diameter of 5 mm. The distance traveled by the steel ball is reported, in cm. In the case of figures above 50 cm the adhesive tape in question is no longer considered to be tacky.

### Production of Test Specimens

### Preparation of a Raft Regulator:

The bis-2,2′-phenylethyl trithiocarbonate regulator was prepared starting from 2-phenylethyl bromide using carbon disulphide and sodium hydroxide in accordance with a set of instructions in Synth. Comm., 1988, 18 (13), 1531. Yield: 72%. ¹H-NMR (CDCl₃), δ: 7.20-7.40 ppm (m, 10H); 3.81 ppm (m, 1H); 3.71 ppm (m, 1H); 1.59 ppm (d, 3H); 1.53 ppm (d, 3H).

### Preparation of Polystyrene (A1)

A 2 l reactor conventional for radical polymerization is charged under a nitrogen atmosphere with 1500 g of styrene and 9.80 g of bis-2,2′-phenylethyl trithiocarbonate regulator. This initial charge is heated to an internal temperature of 120° C. and initiated with 0.1 g of Vazo 67® (DuPont). After a reaction time of 24 hours, 200 g of toluene are added. After a reaction time of 36 hours a further 200 g of toluene are added. During the polymerization there is a marked rise in viscosity. After 48 hours the polymerization is terminated.

The polymer is purified by precipitating it from 4.5 liters of methanol, filtering it off on a frit and then drying it in a vacuum drying cabinet.

Gel permeation chromatography (test C) against polystyrene standards gave Mₙ=36 100 g/mol and M_{w}=44 800 g/mol.

### EXAMPLE 1

A reactor conventional for radical polymerizations was charged with 700 g of trithiocarbonate-functionalized polystyrene (A1), 2900 g of n-butyl acrylate, 150 g of glycidyl methacrylate and 1600 g of acetone. This initial charge was heated to an internal temperature of 65° C. with stirring and under nitrogen gas, and 0.1 g of Vazo 67™ (DuPont) was added. The reactor was heated to 70° C. with stirring, polymerization was carried out for 24 h and then the batch was reinitiated with 0.1 g of Vazo 67® (DuPont).

After the polymerization had been ended, after 48 h, by cooling to room temperature, the hotmelt was isolated by removing the solvent in a vacuum drying cabinet at 50° C. under a pressure of 10 mm. Gel permeation chromatography (test C) against polystyrene standards gave Mₙ=102 700 g/mol and M_{w}=232 000 g/mol.

Subsequently the polymer was dissolved in butanone (to prepare a 45% strength solution) and then blended with 10% by weight of EPR 191 (bisphenol A resin, 60° C. softening range, Bakelite) and 1.5% of dicyandiamide and the solution was homogenized. To produce the heat-activable adhesive tape the solution is subsequently coated onto a siliconized glassine paper and then dried at 90° C. for 10 minutes. The coatweight after drying was 50 g/m².

### EXAMPLE 2

The block copolymer from Example 1 was dissolved in butanone (to prepare a 45% strength solution) and then blended with 10% by weight of EPR 194 (bisphenol A resin, 90° C. softening range, Bakelite) and 1.5% of dicyandiamide and the solution was homogenized. To produce the heat-activable adhesive tape the solution is subsequently coated onto a siliconized glassine paper and then dried at 90° C. for 10 minutes. The coatweight after drying was 50 g/m².

### EXAMPLE 3

A reactor conventional for radical polymerizations was charged with 45.9 g of trithiocarbonate-functionalized polystyrene (A1), 450 g of 2-ethylhexyl acrylate, 50 g of glycidyl methacrylate and 0.12 g of Vazo 67™ (DuPont). After argon had been passed through the reactor for 20 minutes and the reactor had been degassed twice, the reactor was heated to 70° C. with stirring, polymerization was carried out for 24 h and then the batch was reinitiated with 0.1 g of Vazo 67® (DuPont). After the polymerization had been ended, after 48 h, by cooling to room temperature, the hotmelt was isolated by removing the solvent in a vacuum drying cabinet at 50° C. under a pressure of 10 mm. Gel permeation chromatography (test C) against polystyrene standards gave Mₙ=107 500 g/mol and M_{w}=229 500 g/mol.

Subsequently the polymer was dissolved in butanone (to prepare a 45% strength solution) and then blended with 10% by weight of EPR 191 (bisphenol A resin, 60° C. softening range, Bakelite) and 2.0% of dicyandiamide and the solution was homogenized. To produce the heat-activable adhesive tape the solution is subsequently coated onto a siliconized glassine paper and then dried at 90° C. for 10 minutes. The coatweight after drying was 50 g/m².

### EXAMPLE 4

The block copolymer from Example 3 was dissolved in butanone (to prepare a 45% strength solution) and then blended with 10% by weight of EPR 194 (bisphenol A resin, 90° C. softening range, Bakelite) and 2.0% of dicyandiamide and the solution was homogenized. To produce the heat-activable adhesive tape the solution is subsequently coated onto a siliconized glassine paper and then dried at 90° C. for 10 minutes. The coatweight after drying was 50 g/m².

### EXAMPLE 5

A reactor conventional for radical polymerizations was charged with 700 g of trithiocarbonate-functionalized polystyrene (A1), 3063 g of n-butyl acrylate, and 1600 g of acetone. This initial charge was heated to an internal temperature of 65° C. with stirring and under nitrogen gas, and 0.1 g of Vazo 67™ (DuPont) was added. The reactor was heated to 70° C. with stirring, polymerization was carried out for 24 h and then the batch was reinitiated with 0.1 g of Vazo 67® (DuPont). After the polymerization had been ended, after 48 h, by cooling to room temperature, the hotmelt was isolated by removing the solvent in a vacuum drying cabinet at 50° C. under a pressure of 10 mm. Gel permeation chromatography (test C) against polystyrene standards gave Mₙ=111 300 g/mol and M_{w}=197 000 g/mol.

Subsequently the polymer was dissolved in butanone (to prepare a 45% strength solution) and then blended with 10% by weight of EPR 191 (bisphenol A resin, 60° C. softening range, Bakelite), 10% by weight of DT 110 (terpene-phenolic resin from DRT, softening range 110° C.) and 0.5% of dicyandiamide and the solution was homogenized. To produce the tacky, heat-activable adhesive tape the solution is subsequently coated onto a siliconized glassine paper and then dried at 90° C. for 10 minutes. The coatweight after drying was 50 g/m².

### EXAMPLE 6

The block copolymer from Example 5 was dissolved in butanone (to prepare a 45% strength solution) and then blended with 10% by weight of EPR 194 (bisphenol A resin, 90° C. softening range, Bakelite), 20% by weight of DT 110 (terpene-phenolic resin from DRT, softening range 110° C.) and 0.5% of dicyandiamide and the solution was homogenized. To produce the tacky, heat-activable adhesive tape the solution is subsequently coated onto a siliconized glassine paper and then dried at 90° C. for 10 minutes. The coatweight after drying was 50 g/m².

### EXAMPLE 7

A reactor conventional for radical polymerizations was charged with 45.9 g of trithiocarbonate-functionalized polystyrene (A1), 460 g of 2-ethylhexyl acrylate and 0.12 g of Vazo 67™ (DuPont). After argon had been passed through the reactor for 20 minutes and the reactor had been degassed twice, the reactor was heated to 70° C. with stirring, polymerization was carried out for 24 h and then the batch was reinitiated with 0.1 g of Vazo 67® (DuPont). After the polymerization had been ended, after 48 h, by cooling to room temperature, the hotmelt was isolated by removing the solvent in a vacuum drying cabinet at 50° C. under a pressure of 10 mm. Gel permeation chromatography (test C) against polystyrene standards gave Mₙ=94 500 g/mol and M_{w}=189 100 g/mol. Subsequently the polymer was dissolved in butanone (to prepare a 45% strength solution) and then blended with 10% by weight of EPR 191 (bisphenol A resin, 60° C. softening range, Bakelite), 10% by weight of DT 110 (terpene-phenolic resin from DRT, softening range 110° C.) and 0.5% of dicyandiamide and the solution was homogenized. To produce the tacky, heat-activable adhesive tape the solution is subsequently coated onto a siliconized glassine paper and then dried at 90° C. for 10 minutes. The coatweight after drying was 50 g/m².

### EXAMPLE 8

The block copolymer from Example 7 was dissolved in butanone (to prepare a 45% strength solution) and then blended with 10% by weight of EPR 194 (bisphenol A resin, 90° C. softening range, Bakelite), 20% by weight of DT 110 (terpene-phenolic resin from DRT, softening range 110° C.) and 0.5% of dicyandiamide and the solution was homogenized. To produce the heat-activable adhesive tape the solution is subsequently coated onto a siliconized glassine paper and then dried at 90° C. for 10 minutes. The coatweight after drying was 50 g/m².

### Results:

### Non-Tacky or Barely Tacky Alternative Embodiment

For adhesive assessment of the abovementioned Examples 1 to 4 first of all the T-peel test (Test A) with FPCB laminates was carried out. The corresponding measurements are listed in Table 1.

TABLE 1

| | Test A/T-peel test |
|---|---|
| | [N/cm] |
| Example 1 | 12.5 |
| Example 2 | 11.8 |
| Example 3 | 14.7 |
| Example 4 | 13.2 |

From Table 1 it is apparent that with Examples 1-4 very high bond strengths were obtained after just 30 minutes' curing.

A further criterion is the solder bath resistance of the materials (Test B). From Table 2 it is apparent that all of the inventive examples possess solder bath resistance.

TABLE 2

| | Test B/solder |
|---|---|
| | bath resistance |
| Example 1 | pass |
| Example 2 | pass |
| Example 3 | pass |
| Example 4 | pass |

To examine the tack of the examples the rolling ball test (Test D) was carried out as well.

The results of this measurement are listed in Table 3.

TABLE 3

| | Test D/rolling ball tack |
|---|---|
| | [cm] |
| Example 1 | >50 |
| Example 2 | >50 |
| Example 3 | >50 |
| Example 4 | >50 |

From Table 3 it is apparent that all of Examples 1 to 4 have no tacky properties. In summary, the inventive heat-activable adhesives are solder bath resistant, and possess high bond strengths on polyimide for the bonding and production of FPCB laminates.

### TACKY ALTERNATIVE EMBODIMENT

For adhesive assessment of the abovementioned Examples 5 to 8 first of all the T-peel test (Test A) with FPCB laminates was carried out again. The corresponding measurements are listed in Table 4.

TABLE 4

| | Test A/T-peel test |
|---|---|
| | [N/cm] |
| Example 5 | 8.1 |
| Example 6 | 9.2 |
| Example 7 | 9.7 |
| Example 8 | 10.2 |

From Table 4 it is apparent that with Examples 5-8 very high bond strengths were obtained after just 30 minutes' curing.

A further criterion here is also the solder bath resistance of the materials (Test B). From Table 5 it is apparent that all of the inventive examples possess solder bath resistance.

TABLE 5

| | Test B/solder bath |
|---|---|
| | resistance |
| Example 5 | pass |
| Example 6 | pass |
| Example 7 | pass |
| Example 8 | pass |

To examine the tack of the examples the rolling ball test (Test D) was carried out for these examples as well. The results of this measurement are listed in Table 6.

TABLE 6

| | Test D/rolling ball tack |
|---|---|
| | [cm] |
| Example 5 | 13 |
| Example 6 | 9 |
| Example 7 | 17 |
| Example 8 | 12 |

From Table 6 it is apparent that all of Examples 5 to 8 have tacky properties and the tack increases when the fraction of DT 110 tackifier resin is increased. In summary, the inventive heat-activable adhesives in accordance with Examples 5 to 8 have tack for pre-fixing, are solder bath resistant, and possess high bond strengths on polyimide for the bonding and production of FPCB laminates.

1. Heat-activable adhesive, comprising
a) at least one acrylate-containing block copolymer, in a proportion of 40-98% by weight
b) one or more tackifying epoxy and/or novolak and/or phenolic resins, in a proportion of 2-60% by weight.

2. The heat-activable adhesive according to claim 1, further comprising
c) at least one hardener for crosslinking the epoxy, novolak and/or phenolic resins, in a proportion of up to 10% by weight based on the adhesive incl. hardener.

3. Heat-activable adhesive according to claim 1, wherein the acrylate-containing block copolymer comprises at least two polymer blocks P(A) and P(B) which are linked chemically to one another and which under application conditions undergo segregation into at least two microphase-separated regions, the microphase-separated regions each having softening temperatures in the range between −125° C. and +20° C.

4. Heat-activable adhesive according to claim 1, wherein the acrylate-containing block copolymer is described by the stoichiometric formula [P(A)ᵢP(B)ⱼ]ₖ (I), and is comprised of diblock copolymers of formula (I) with i=j=k=1 and/or triblock copolymers of formula (I) with i+j=3 (i, j>0) and k=1.

5. Heat-activable adhesive according to claim 1 wherein the block copolymer has a polymer block sequence of the type P(A)-P(B/D), where
P(A) represents a polymer block which can be obtained by polymerizing at least one monomer of type A,
P(A) having a softening temperature of between −125° C. and +20° C.
P(B/D) represents a copolymer block which can be obtained by copolymerizing at least one monomer of type B and at least one monomer of type D, P(B/D) having a softening temperature of between −125° C. and +20° C., and the monomers of type D possessing at least one functional group which behaves substantially inertly in a free-radical copolymerization reaction,
Polymer blocks P(A) and P(B/D) are in microphase-separated form under application conditions, and so the polymer blocks P(A) and P(B/D) are not completely (homogeneously) miscible under application conditions.

6. Heat-activable adhesive according to claim 1, wherein block copolymers used are those of the type P(B/D)-P(A/C)-P(B/D), composed of a central polymer block P(A/C) and two polymer blocks P(B/D) attached to it on either side, in which
P(B/D) and P(A/C) each represent a copolymer block, P(A/C) which can be obtained by copolymerizing at least one monomer of type A with at least one monomer of type C and P(B/D) which can be obtained by copolymerizing at least one monomer of type C with at least one monomer of type D,
P(B/D) and P(A/C) each having a softening temperature of between −125° C. and +20° C.,
the monomers C and D possessing at least one functional group which behaves substantially inertly in a free-radical polymerization reaction,
the polymer blocks P(A/C) and polymer blocks P(B/D) are in microphase-separated form, and so the polymer blocks P(B/D) and P(A/C) are not completely (homogeneously) miscible under application conditions.

7. Heat-activable adhesive according to claim 1, wherein the block copolymers are linear and/or star-shaped multiblock copolymers.

8. Heat-activable adhesive according to claim 7, wherein the multiblock copolymers are one or more compounds whose structure is as follows:
[P(E₁)]-[P(E₂)]-[P(E₃)]- . . . -[P(Eₘ)] with m>3 (II)
{[P(E_{1,δ}-]-[P(E_{2,δ}-]-[P(E_{3,δ}-)]- . . . -[P(E_{n,δ}-)]}ₓX with x>2, n>1, (III)
serial number δ=1, 2, . . . , x
where
P(E) represents polymer blocks which can be obtained by polymerizing at least one monomer of a type E,
(II) a linear multiblock copolymer composed of m identical or different polymer blocks
(III) a star-shaped multiblock copolymer with a polyfunctional crosslinking region X, in which x polymer arms are joined to one another chemically, each polymer arm is composed of at least one polymer block P(E),
The individual polymer blocks P(E) have a softening temperature of between −125 and +20° C., and the monomers of type C possessing at least one functional group which behaves substantially inertly in a free-radical copolymerization reaction,
the polymers are in microphase-separated form under application conditions, and so the individual polymer blocks are not completely (homogeneously) miscible under application conditions.

9. Adhesive according to claim 8, wherein some or all of the polymer blocks P(E) are each replaced by polymer blocks P(E/F), obtainable by copolymerizing at least one monomer of type E and also at least one monomer of a second type F.

10. Adhesive according to claim 1, said adhesive being a contact adhesive, preferably having tacky properties.

11. A method for bonding and/or fabricating circuit boards, wherein said circuit boards are bonded or fabricated with the heat-activable adhesive of claim 1.

12. The method of claim 11 wherein said circuit boards are FPCBs based on polyimide, based on polyethylene naphthalate or based on polyethylene terephthalate.

13. A method for producing diecuts or roll products which comprises producing said diecuts or roll products with sheets of the heat activable adhesive of claim 1.

14. A method for masking copper conductor tracks for FPCBs, which comprises coating the heat-activable adhesive of claim 1 onto a backing to form an adhesive tape, and masking said copper conductor tracks with said adhesive tape.

15. The method of claim 14, wherein said masking is completed in a hot press process at temperatures above 80° C.

16. The method of claim 12, wherein said bonding is completed in a hot press process at temperatures above 80° C.

17. The method of claim 12, wherein said masking is completed in a hot press process at temperatures above 80° C.
